(19) United States
(12) Patent Application Publication
(10) Pub. No.: US 2004/0174014 A1
(43) Pub. Date: Sep. 9, 2004

(54) HOSE ASSEMBLY AND METHOD OF MAKING

(76) Inventors: Michael R. Storage, Beavercreek, OH (US); Mark E. Mehl, Centerville, OH (US); David B. Rader, Urbana, OH (US)

Correspondence Address: MOORE & VAN ALLEN, PLLC, 2200 W MAIN STREET, SUITE 800, DURHAM, NC, 27705, US

(21) Appl. No.: 10/249,000

(22) Filed: Mar. 7, 2003

(51) Int. Cl. F16L 13/02; F16L 35/00; F16L 47/02

(52) U.S. Cl. 285/21.1

(57) ABSTRACT

A hose assembly and method of making the hose assembly are disclosed. The method of making the hose assembly may include inserting an end of a hose into a sleeve portion of a fitting. The hose may have an outer diameter relative to an inner diameter of the sleeve portion to cause contact between an exterior of the hose and the sleeve portion of the fitting. A magnetic pulse may be directed on the sleeve portion of the fitting and the end of the hose within the sleeve portion to form one of a metallurgical bond, a molecular bond or a mechanical bond between the sleeve portion of the fitting and the hose without heat damaging the hose assembly.

### BACKGROUND OF INVENTION

### FIELD OF THE INVENTION

The present invention relates to hose assemblies and the like and more particularly to a hose assembly and method of making the hose assembly using electromagnetic forming, magnetic pulse welding or the like to reliably and repeatably attach a fitting to a hose.

Machinery, engines and the like, such as gas turbine engines for aircraft, marine and industrial applications, include numerous hose assemblies that interconnect various components of the machinery or engine. For example, hose assemblies may form a circuit from an oil pump and reservoir to parts of the machine or engine that require lubrication and back to the reservoir through a filter and possibly a heat exchanger. Hose assemblies may also be used to route hydraulic fluids to components operated by hydraulic pressure or to supply fuel to combustors, fuel injectors or the like of an engine. These hose assemblies typically have fittings or connectors on the ends to connect the hose to the different components. Because these hose assemblies can operate in extremely harsh environments, with large variances in temperature, large amplitude vibrations and can be subjected to enormous stresses and forces both internally and externally, the hose fittings need to be securely and reliably attached to the hose. Currently, fittings or connectors are typically attached to hoses by swaging or crimping a collar around the exterior of the hose at the fitting with a portion of the fitting inserted into the end of the hose. The pressure of the crimped collar in securing the fitting can be nonuniform or inconsistent around the circumference of the hose resulting in unreliability of the connection. Additionally, the pressure applied by a crimping or swaging tool or machine in swaging the collar can differ from one machine to another resulting in inconsistencies and nonrepeatability. The collar, hose and fitting may also be fusion welded to provide a more secure connection but such processes can be inconsistent and thermal damage to the hose can result. Additionally, typically only exposed portions of the collar, hose and fitting can be welded and joining dissimilar materials can require special processing. Such a welding process adds additional steps to the manufacturing process that increases the expense of the hose assembly.

Accordingly, there is a need to provide a method to securely and reliably attach a fitting to a hose to provide a hose assembly that can withstand the extreme stresses and forces of the potential operating environment. Additionally, there is a need to provide a method to securely attach a fitting to a hose that is repeatable from one hose assembly to another and provides consistent reliability. There is also a need to provide a method to securely attach a fitting to a hose that is efficient, involving a minimum of process operations and that does not present a possible risk of damaging the hose assembly.

### SUMMARY OF INVENTION

In accordance with an embodiment of the present invention, a method of making a hose assembly may include inserting an end of a hose into a sleeve portion of a fitting. The hose may have an outer diameter relative to an inner diameter of the sleeve portion to cause contact between an exterior of the hose and the sleeve portion of the fitting. A magnetic pulse may be directed on the sleeve portion of the fitting and the end of the hose within the sleeve portion to form one of a metallurgical bond, a molecular bond or a mechanical bond between the sleeve portion of the fitting and the hose without heat damaging the hose assembly.

In accordance with an embodiment of the present invention, a method of making a hose assembly may include providing a hose that includes at least an inner hose portion and an outer hose covering formed from a metallic type material or the like. A cylindrical portion of a metallic fitting may be inserted into the inner hose portion of the hose and the cylindrical portion of the fitting may have a diameter relative to a diameter of the inner hose portion to contact the inner hose portion. A magnetic pulse or the like may be directed on the fitting and the hose to form one of a metallurgical bond, a molecular bond or mechanical bond between the fitting and the outer hose without heat damaging the hose assembly. A mechanical bond may be formed between the fitting and the inner hose portion, if the inner hose portion is a polymeric type material, and a metallurgical, molecular or mechanical bond may be formed between the fitting and the inner hose portion, if the inner hose portion is a metallic type material.

In accordance with another embodiment of the present invention, a method of making a hose assembly for a gas turbine engine may include providing a hose that includes at least an inner hose portion and a metallic outer hose covering. A cylindrical portion of a metallic fitting may be inserted into the inner hose portion of the hose. A metallurgical bond, molecular bond or mechanical bond may be formed between the fitting and the outer hose covering by magnetic pulse welding, electromagnetic forming or the like without heat damaging the hose assembly. The completed hose assembly may be attached to a gas turbine engine or the like. In another embodiment, the inner hose portion and the outer hose covering may be inserted into the cylindrical portion of the fitting.

In accordance with a further embodiment of the present invention, a hose assembly may include a hose including at least an inner hose portion and an outer hose covering formed from a metallic type material. A metallic fitting with a cylindrical portion may be provided and the cylindrical portion may be inserted into the hose. The hose assembly may further include a metallurgical bond, a molecular bond, a mechanical bond or the like formed between the outer hose covering and the fitting without heat damaging the hose assembly. In another embodiment, the inner hose portion and the outer hose covering may be inserted into the cylindrical portion of the fitting.

### BRIEF DESCRIPTION OF DRAWINGS

FIG. 1 is a cross-sectional view of a hose assembly in a device for electromagnetic forming or magnetic pulse welding in accordance with an embodiment of the present invention.

FIG. 2 is a cross-sectional view of the hose assembly after electromagnetic forming or magnetic pulse welding in accordance with an embodiment of the present invention.

FIG. 3 is a flow chart of a method of making a hose assembly for a gas turbine engine in accordance with an embodiment of the present invention.

FIG. 4 is a cross-sectional view of a hose assembly formed by electromagnetic forming or magnetic pulse welding in accordance with another embodiment of the present invention.

FIG. 5 is a cross sectional view of a hose assembly formed by electromagnetic forming or magnetic pulse welding in accordance with a further embodiment of the present invention.

FIG. 6 is an elevational, partial sectional view of an exemplary ball joint formed by electromagnetic forming or magnetic pulse welding in accordance with an embodiment of the present invention.

### DETAILED DESCRIPTION

The following detailed description of preferred embodiments refers to the accompanying drawings which illustrate specific embodiments of the invention. Other embodiments having different structures and operations do not depart from the scope of the present invention.

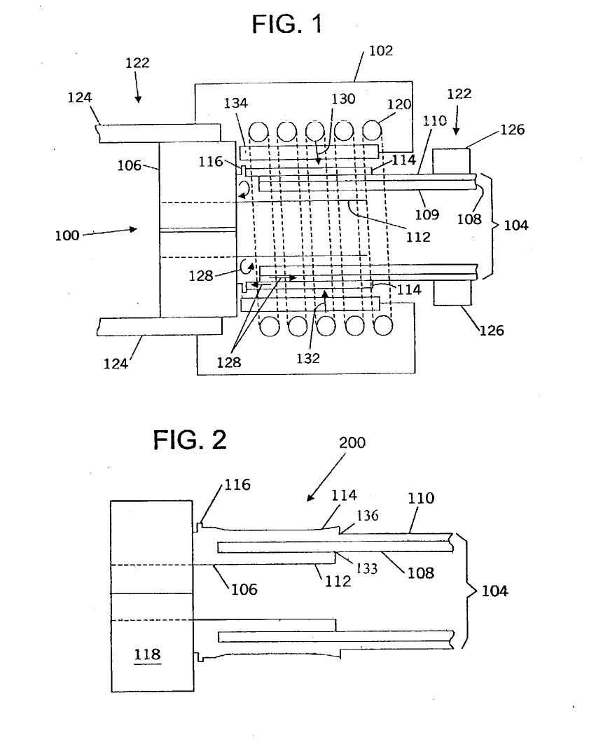

FIG. 1 is a cross-sectional view of a hose assembly 100 in a device 102 for performing electromagnetic forming, magnetic pulse welding or the like in accordance with an embodiment of the present invention. The hose assembly 100 may include a conduit or flexible hose 104 and a metallic fitting 106, connector or the like. The flexible hose 104 may include at least an inner hose portion 108 and an outer hose covering 110. The inner hose portion 108 may be formed from a metallic type material, a polymeric material, such as polytetrafluoroethylene (PTFE), or similar flexible material. The outer hose covering 110 may be a flexible metallic type material, such as a braided stainless steel wire, braided aluminum wire or the like.

The fitting 106 may include a cylindrical or sleeve portion 112 that may be slid into the inner portion 108 of the hose 104. The sleeve portion 112 may have a diameter relative to a diameter of the inner hose portion 108 to contact an interior wall 109 of the inner hose portion 108. In another embodiment, the inner hose portion 108 may be formed of a resilient material that permits the inner hose portion 108 to expand slightly to receive the sleeve portion 112. A metallic collar 114 may be slid over the outer hose covering 110 prior to inserting the sleeve portion 112 of the fitting 106 into the inner hose portion 108. The metallic collar 114 may be positioned to substantially overlie the sleeve portion 112 of the fitting 106. A land or a flange 116 may be formed extending from the sleeve portion 112 proximate to a nut or fastener 118 formed on the fitting 106. The land 116 may extend substantially completely around a circumference of the sleeve portion 112. The collar 114 may butt against the land 116 to substantially completely overlie the sleeve portion 112 inserted into the inner hose portion 108. The metallic collar 114 may extend substantially completely around the circumference of the outer hose covering 110 and may fit on the covering 110 with a close tolerance so as to slidingly contact the metallic outer covering 110.

The magnetic pulse welding (MPW) device 102, electromagnetic forming (EMF) device or the like may include a conductive coil 120 to generate electromagnetic or magnetic pulses for welding or forming. The device 102 may be similar to those made by Pulsar Technology Industries of Yavne, Israel or the like. The coil 120 may be substantially circular although other shapes may be possible to focus magnetic fields or pulses in particular directions. The hose assembly 100 may be held in position within the coil 120 by an adjustable fixture or fixtures 122. The fixture 122 may include a first component or components 124 to retain the fitting 106 in proper position and a second component or components 126 to hold the hose in proper position during magnetic pulse welding or forming. In operation, a high energy current may be discharged through the coil 120 to create eddy currents (represented by arrows 128 in FIG. 1) in the metallic collar 114, the metallic fitting 116 and the metallic outer hose covering 110. The current discharge also creates two opposing instantaneous magnetic fields or magnetic pulses represented by arrows 130 and 132 respectively. The two magnetic fields 130 and 132 may repel each other with a force proportional to the square of the discharge current. The two opposing magnetic fields or pulses 130 and 132 force the hose assembly 100 away from the coil 120 or exert a force on the hose assembly 100 substantially completely around a circumference of the hose assembly. The magnitude of the magnetic pulses 130 and 132 preferably exert sufficient force to cause the metallic collar 114, outer hose covering 110 and metallic fitting 106 into their respective plastic regions and to form a molecular bond, metallurgical bond or mechanical bond 133 at their respective interfaces. The device 102 may also include a magnetic field shaping device 134 to focus the magnetic energy on to the hose assembly 100. The process is a cold process with negligible heat or thermal energy being generated that can damage the hose assembly 100. The fixture components 124 and 126 may cause contact between the collar 114, the outer hose covering 110 and the fitting 106 during the magnetic pulse welding or electromagnetic forming to facilitate the metallurgical bonding.

The magnetic pulse welding may be independent of the type of metal or alloy forming the collar 114, the outer hose covering 110 and the fitting 106. Metals or alloys with lower conductivity may require greater energy and a higher frequency of operation.

An illustration of the resulting hose assembly 200 after the magnetic pulse welding operation is shown in FIG. 2. The collar 114 may be metallurgically or molecularly bonded to the outer hose covering 110 substantially completely along the extent of the collar 114 and substantially completely around the circumference of the outer hose covering 110. Additionally, the collar 114 and the outer hose covering 110 may both also be metallurgically or molecularly bonded to the fitting 106 substantially completely around the circumference of the hose 104. In another embodiment, a mechanical bond may be formed at the interface of some components. All bonds may be formed in a single operation with no thermal energy or heat that can damage the assembly. The metallurgical or molecular bonds may be substantially seamless and may form a very secure connection or seal 136. The discharge current and the magnitude of the magnetic pulses 130 and 132 operation can be controlled and therefore the process is highly repeatable and provides consistent results.

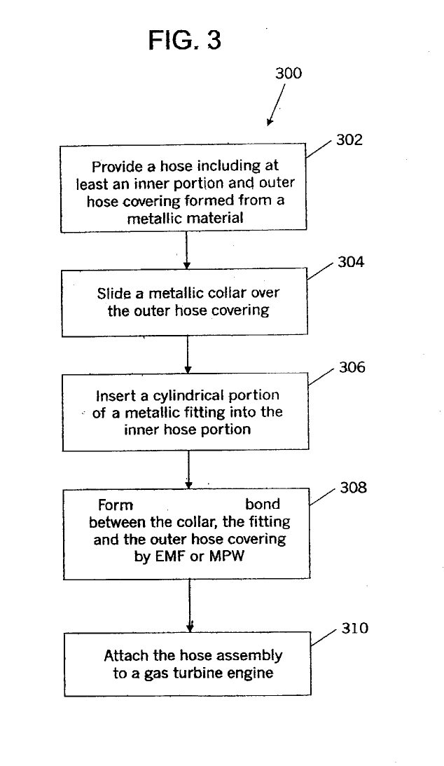

FIG. 3 is a flow chart of a method 300 of making a hose assembly, similar to the hose assembly 200 in FIG. 2 for a gas turbine engine or the like in accordance with an embodiment of the present invention. In block 302, a hose or conduit, similar to hose 104 in FIGS. 1 and 2 or the like, may be provided with at least an inner portion 108 and an outer hose covering 110. In block 304, a metallic collar, similar to the collar 114, may be slid over the outer hose covering 110. A cylindrical or sleeve portion of a metallic fitting, connector, or coupling, similar to the fitting 106 in FIG. 1 or the like, may be inserted into the inner hose portion 108 in block 306. In an alternate embodiment, the hose may be inserted into the cylindrical portion of the fitting. In block 308, a metallurgical, molecular or mechanical bond may be formed between the collar 114, the fitting 106 and the outer hose covering 110 by electromagnetic forming (EMF), magnetic pulse welding (MPW) or the like. In block 310, the completed hose assembly may be attached to a gas turbine engine or the like.

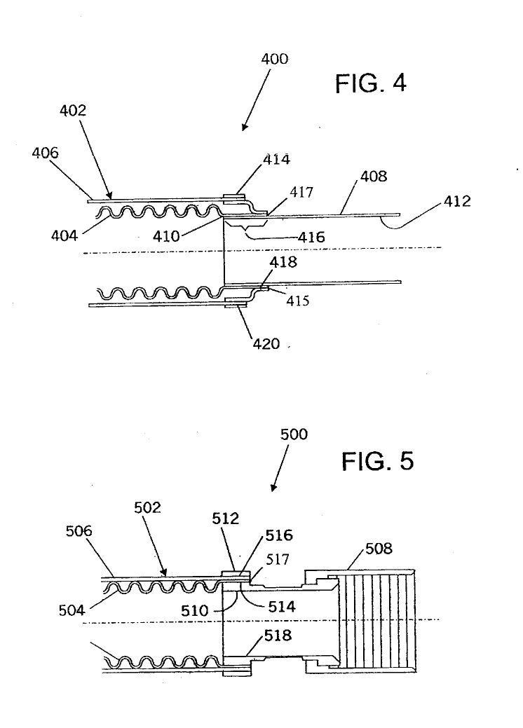

FIG. 4 is a cross-sectional view of a hose assembly 400 formed by electromagnetic forming (EMF) or magnetic pulse welding (MPW) in accordance with another embodiment of the present invention. The hose assembly 400 may include a hose 402 with an inner hose portion 404 and an outer hose covering 406. The inner hose portion 404 may include a convoluted, thin-walled bellows that permits the hose 402 to flex. The inner hose portion 404 may be made from a thin-walled metallic type material or the like. The outer hose covering 406 may be a flexible material, such as a braided stainless steel wire, aluminum wire or a similar material. A tubular fitting 408 or the like may be inserted into the inner hose portion 402 and contact an interior wall 410 of the inner hose portion 404. In an alternate embodiment, the tubular fitting 408 may have a diameter to fit with a close tolerance over the outer hose covering 406 with the outer covering 406 in contact with an interior wall 412 of the tubular fitting 408. In one embodiment, a metallic collar 414 may be disposed over the outer hose covering 406 as shown in FIG. 4 or over the fitting 408 if the hose 402 is inserted into the fitting 408. In other embodiments, the collar 414 may not be used.

The hose assembly 400 may be inserted into a device for magnetic pulse welding or electromagnetic forming, such as the MPW or EMF device 102 shown in FIG. 1 or a similar device. The MPW/EMF device may be energized to form a metallurgical bond, molecular bond or mechanical bond 415, between the fitting 408, inner hose portion 404 and outer hose covering 406. A metallurgical, molecular or mechanical bond 415 may be formed depending upon the types of materials that interface with one another in the hose assembly. For example, if the inner hose portion 404 is a thin-walled metallic type material and the tubular fitting 408 is a metallic type material a metallurgical or molecular bond may be formed between the inner portion 402 and the fitting 408 substantially completely across an interface 416 between the inner portion 402 and the fitting 408 and around a circumference of the hose 402 to form a seal 417. A standard welding or joining operation may only be able to weld or join those portions of the inner hose portion 404 and the fitting 408 that are exposed.

Similarly, if the outer hose covering 406 is a metallic type material and the fitting 408 and collar 414 are a metallic type material, a metallurgical or molecular bond 415 may be formed by MPW/EMF substantially completely across an interface 418 between the outer hose covering 406 and the fitting 408 and an interface 420 between the collar 414 and the outer hose covering 406. Conventional welding or joining processes may only be able to join those portions of the outer covering 406, fitting 408 and collar 414 that are exposed. A mechanical bond may be formed at any interfaces where one or both of the materials are non-metallic or do not react to the MPW/EMF process.

FIG. 5 is a cross-sectional view of a hose assembly 500 formed by electromagnetic forming (EMF) or magnetic pulse welding (MPW) in accordance with a further embodiment of the present invention. The hose assembly 500 may be substantially similar to the hose assembly 400 of FIG. 4 except the tubular fitting 408 may be replaced with a threaded fitting 508. The hose assembly 500 may include a conduit or hose 502 with an inner hose portion 504 and an outer hose covering 506. The inner hose portion 504 may include a convoluted, thin-walled bellows that permits the hose 502 to flex. The inner hose portion 504 may be made from a thin walled metallic type material or the like. The outer hose covering 506 may be flexible material, such as a braided stainless steel wire, aluminum wire or a similar material. A flange segment 5 10 of the threaded fitting 508 may be inserted into the inner hose portion 504. In one embodiment, a collar 512 may be disposed over the outer hose covering 506. A metallurgical, molecular or mechanical bond may be formed at an interface 514 between fitting flange segment 510 and the inner hose portion 504 and at an interface 516 between the outer hose covering 506 and the collar 512 by EMF or MPW, if the collar 512 is used in the embodiment. Accordingly, a seal 517 may be formed by the bond extending substantially completely along the extents and perimeters of the interfaces 514 and 516.

While the flange segment 510 of the fitting 508 is shown inserted into the inner hose portion 504, in an alternate embodiment (not shown in the Figures) the flange segment 510 may be sized so that the hose 502 may be inserted into the flange segment 510 with the outer hose covering 506 contacting an interior wall 518 of the fitting 508. A metallurgical, molecular or mechanical bond may then be formed between the interior wall 518 of the fitting 508 and the outer hose covering 502 by EMF or MPW.

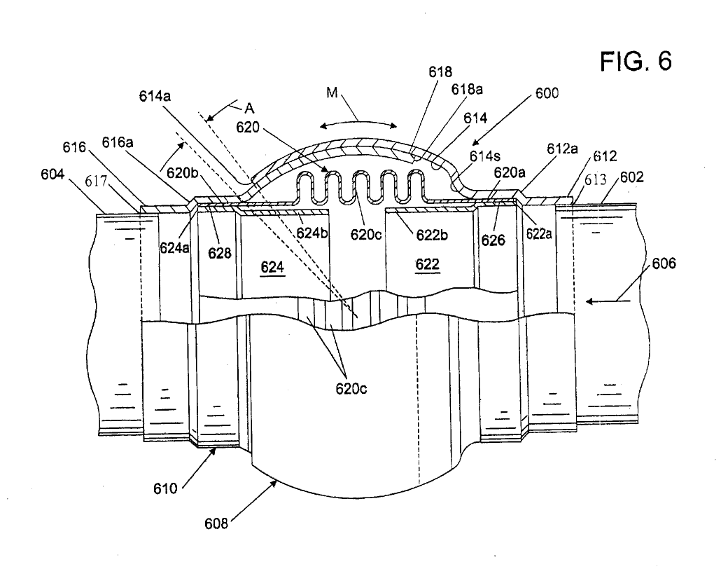

FIG. 6 is an elevational, partial sectional view of an exemplary embodiment of a ball-and-socket joint or simply ball joint 600 after electromagnetic forming or magnetic pulse welding in accordance with an embodiment of the present invention. The ball joint 600 may be used to join in fluid flow communication a first tubular conduit 602 and a second tubular conduit 604. In the exemplary embodiment illustrated, the ball joint 600 may be used for carrying a fluid 606, such as compressor bleed air, fuel, or oil, in an aircraft gas turbine engine or the like or between the engine and an aircraft in which the engine may be mounted, or in the aircraft itself. The ball joint 600 may be specifically configured to prevent leakage of the fluid 606 while allowing pivotal or articulated movement M between the first and second conduits 602 and 604 as desired. The motion results in lower stresses in the conduits 602 and 604, thus allowing them to be produced from lighter weight and lower cost materials.

The ball joint 600 may include a tubular outer fitting or shroud 608 that may surround in part a coaxial tubular inner fitting or shroud 610 to allow the pivotal movement M. The outer shroud 608 may be one piece and may include at a proximal end thereof an integral first cylindrical sleeve 612 adapted to be joined to the first conduit 602 by MPW or EMF to form a seal 613. Another end of the outer shroud 608 may include an integral spherical, concave annulus defining a unique one-piece weld-free socket 614 around the inner surface thereof.

The inner shroud 610 may also be one piece and may include at a proximal end thereof an integral second cylindrical sleeve 616 adapted to be joined to the second conduit 604 by MPW or EMF to form a seal 617 in accordance with an embodiment of the present invention. A distal end of the inner shroud 610 may include an integral spherical, convex annulus defining a smooth ball 618 around its outer surface that may be complementary with the socket 614. The outer diameter of the ball 618 may be nominally equal to the inner diameter of the socket 614, with the ball 618 being disposed in abutting, slidable contact with the socket 614 for holding or joining together the outer and inner shrouds 608, 610 while allowing a predetermined amount of pivoting angular movement M therebetween. A suitable coating may be applied on the ball 618 for reducing friction and reducing bending moment.

Both the outer and inner shrouds 608 and 610 may be formed from conventional, thin wall tubing having generally smooth surfaces. Both the ball 618 and the socket 614 may be axially and circumferentially continuous or smooth without indentations, tabs, holes, etc. However, such additional features may be used for reducing weight if desired. Each of the ball 618 and socket 614 may be an annulus portion of a sphere defined between axially spaced apart parallel planes with the convex outer surface of the ball 618 being smooth and uninterrupted between its two axial end planes, and the concave inner surface of the socket 614 also being smooth and uninterrupted between its opposite end planes.

Since the adjoining ball 618 and socket 614 are not leak proof by themselves, a tubular bellows 620 may be disposed coaxially inside the adjoining outer and inner shrouds 608 and 610 to sealingly join the first and second conduits 602 and 604 while allowing the limited pivotal movement M. The bellows 620 may include a first end 620a sealingly joined by MPW, EMF or the like to the inner surface of the outer shroud 608 adjacent to the first sleeve 612. The bellows 620 may include a second, opposite end 620b similarly sealingly joined by MPW, EMF or the like to the inner surface of the inner shroud 610 adjacent to the second sleeve 616. The bellows 620 may also include a plurality of axially spaced apart convolutions 620c between the first and second ends 620a, b. The convolutions 620c may provide a flexible seal between the outer and inner shrouds 608 and 610 to prevent leakage of the fluid 606 from the first and second conduits 602 and 604. The bellows 620 may be formed of a suitable thin metal stock which may be connected to the metallic outer and inner shrouds 608 and 610 by MPW, EMF or the like.

As shown in FIG. 6, the socket 614 has a distal edge 614a that may be spaced a predetermined space along the ball 618 from its joint with the second sleeve 616 to limit the pivoting movement M between the ball 618 and the socket 614 to a maximum pivoting angle A. The pivoting movement M may be limited by contact between the socket distal edge 614a and the second sleeve 616 where it joins the ball 618. In this way, the ball 618 and the socket 614 which hold together the outer and inner shrouds 608 and 610 also allow limited flexing of the bellows 620 disposed inside the ball 618 and socket 614 to prevent undesirable overtravel of the bellows 620. Similar features may be employed if desired on the other end of the unit, with the ball 618 having a distal edge 618a predeterminedly spaced from a step 614s formed at the proximal end of the socket 614. The maximum pivoting angle A may be selected as desired, but in this exemplary embodiment is less than about 10° and is preferably about 5°.

The first sleeve 612 preferably includes a first annular or cylindrical inside step 612a for predeterminedly seating the bellows first end 620a. Similarly, the second sleeve 616 includes a second annular or cylindrical inside step 616a for predeterminedly seating the bellows second end 620b. In this way, the outer diameter of the bellows first and second ends 620a, b may be made generally equal to the inner diameter of the respective first and second cylindrical steps 612a, 616a for conveniently and accurately trapping the bellows 620 in its proper position within the outer and inner shrouds 608 and 610 prior to MPW, EMF or the like.

In order to reduce pressure losses and/or flow induced vibration due to flow of the fluid 606 along the inner surface of the undulating bellows 620, a first tubular liner 622 may be disposed inside the bellows 620 and may have a first, proximal end 622a fixedly joined by MPW, EMF or the like to the first sleeve 612 adjacent to the bellows first end 620a. Similarly, a second tubular liner 624 is disposed inside the bellows 620 and has a first, proximal end 624a fixedly joined by MPW, EMF or the like to the second sleeve 616 adjacent to the bellows second end 620b substantially completely along an interface between the second sleeve 616 and the liner end 624a. The second liner 624 has an opposite, second distal end 624b which is disposed adjacent to and spaced from a corresponding second distal end 624b of the first liner 622. In a preferred embodiment, the first and second liner first ends 622a, 624a are also seated in the respective first and second steps 612a, 616a along with the bellows first and second ends 620a, b. The first liner 622 and the second liner 624 may be connected to the bellows first end 620a and second end 620b respectively by MPW, EMF or the like substantially completely along an interface 626 and 628 between the liners 622 and 624 and the bellows ends 620a and 620b.

The complete ball joint 600 therefore provides articulation between the ball 618 and the socket 614, with the bellows 620 preventing leakage. The liners 622 and 624 provide a relatively smooth surface along which the flow 606 may travel for reducing pressure losses and/or likelihood of flow induced vibrations therein. The outer surfaces of the liners 622 and 624 are suitably spaced below the bellows convolutions 620c for preventing rubbing contact therebetween while allowing the bellows 620 to pivot for accommodating misalignment between the conduits 602 and 604. MPW, EMF or like also provides a more robust construction with the materials being joined by a metallurgical, molecular or mechanical bond substantially completely along an interface between the components without any heat damage to the components. The bonds at the interfaces between the components may also be formed in a single operation for more efficiency and to reduce manufacturing costs. In an alternate embodiment (not shown), the socket 614 may include at its proximal end, a cylindrical section for allowing limited axial sliding movement between the ball 618 and the socket 614 in addition to the pivoting movement M if desired.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A method of making a hose assembly, comprising:
inserting an end of a hose into a sleeve portion of a fitting, wherein the hose has an outer diameter relative to an inner diameter of the sleeve portion to cause contact between an exterior of the hose and the sleeve portion of the fitting; and
directing a magnetic pulse on the sleeve portion of the fitting and the end of the hose within the sleeve portion to form one of a metallurgical bond, a molecular bond or a mechanical bond between the sleeve portion of the fitting and the hose without heat damaging the hose assembly.

2. The method of claim 1, further comprising directing the magnetic pulse substantially completely along an extent of the sleeve portion of the fitting and substantially completely around a circumference of the sleeve portion of the fitting to cause the metallurgical bond, molecular bond or mechanical bond to form between the sleeve portion of the fitting and the hose substantially completely along the extent and the circumference of the sleeve portion to form a seal.

3. The method of claim 2, wherein the metallurgical bond, molecular bond or mechanical bond between the sleeve portion of the fitting and the hose are formed in a single operation.

4. The method of claim 1, wherein inserting an end of the hose into a sleeve portion of a fitting comprises inserting an end of a conduit into a sleeve of a flexible ball joint.

5. The method of claim 4, wherein directing the magnetic pulse on the sleeve portion of the fitting and the end of the hose comprises directing the magnetic pulse on the sleeve of the flexible ball joint to form one of a metallurgical bond, molecular bond or mechanical bond between the sleeve and an end of the conduit for sealing contact between the sleeve and the end of the conduit.

6. The method of claim 5, further comprising disposing a bellows within the ball joint.

7. The method of claim 6, further comprising directing a magnetic pulse on an end portion of the bellows to form one of a metallurgical bond, molecular bond or mechanical bond between the end portion of the bellows and the ball joint for sealing contact between the end portion of the bellows and the ball joint.

8. The method of claim 7, wherein the metallurgical bond, molecular bond or mechanical bond between the end portion of the bellows and the ball joint and the metallurgical bond, molecular bond or mechanical bond between the conduit and the sleeve are formed in a single operation.

9. The method of claim 8, further comprising disposing a liner within the bellows.

10. The method of claim 9, further comprising directing a magnetic pulse on an end of the liner and the bellows to form one of a metallurgical bond, molecular bond or mechanical bond between the end of the liner and a portion of the bellows.

11. The method of claim 10, wherein all bonds are formed in a single operation.

12. A method of making a hose assembly, comprising:
providing a hose including at least an inner hose portion and an outer hose covering formed from a metallic type material;
inserting a cylindrical portion of a metallic fitting into the inner hose portion of the hose, wherein the cylindrical portion has a diameter relative to a diameter of the inner hose portion to contact the inner hose portion; and
directing a magnetic pulse on the fitting and hose to form one of a metallurgical bond, molecular bond or mechanical bond between the fitting and the outer hose covering without heat damaging the hose assembly.

13. The method of claim 12, further comprising directing the magnetic pulse substantially completely along an extent of the cylindrical portion of the fitting and substantially completely around a circumference of the cylindrical portion of the fitting to cause the metallurgical bond, molecular bond or mechanical bond to form between the cylindrical portion of the fitting and the hose substantially completely along the extent and the circumference of the cylindrical portion to form sealing contact between the cylindrical portion and the hose.

14. The method of claim 13, wherein the metallurgical bond, molecular bond or mechanical bond between the cylindrical portion of the fitting and the outer hose covering are formed in a single operation.

15. The method of claim 12, wherein the metallic fitting and the metallic outer hose covering are formed from the same metal or alloy.

16. The method of claim 12, wherein at least one of the metallic fitting and the metallic outer hose covering are formed from different types of metals or alloys.

17. The method of claim 12, wherein the outer hose covering is formed from a braided wire.

18. The method of claim 12, wherein the inner hose portion is one of a metallic material or a polymeric material.

19. The method of claim 12, further comprising causing contact between the outer hose covering and the fitting.

20. The method of claim 19, wherein causing contact between the outer hose covering and the fitting comprises retaining the fitting and the hose in a fixture with the outer hose covering being forced against the fitting.

21. The method of claim 12, further comprising creating eddy currents within the fitting and outer hose covering.

22. The method of claim 12, wherein providing the hose comprises provide a hose with a convoluted bellows interior portion.

23. The method of claim 22, further comprising directing a magnetic pulse on an end of the convoluted bellows interior portion of the hose to form one of a metallurgical bond, molecular bond or mechanical bond between the interior portion and the fitting.

24. The method of claim 12, further comprising sliding a collar over the outer hose covering.

25. The method of claim 24, further comprising directing a magnetic pulse on the collar to form one of a metallurgical bond, a molecular bond or a mechanical bond between the collar and the outer hose covering.

26. A method of making a hose assembly for a gas turbine engine, comprising:
providing a hose including at least an inner hose portion and a metallic outer hose covering;
inserting a cylindrical portion of a metallic fitting into an end of the hose;
forming one of a metallurgical bond, a molecular bond or a mechanical bond between the fitting and the outer hose covering without heat damaging the hose; and
attaching the hose assembly to a gas turbine engine.

27. The method of claim 26, wherein forming the metallurgical bond, molecular bond or mechanical bond comprises one of electromagnetic forming (EMF) or magnetic pulse welding (MPW).

28. The method of claim 26, wherein forming the metallurgical bond, molecular bond or mechanical bond comprises directing a magnetic pulse substantially completely along an extent of the cylindrical portion of the fitting and around a circumference of the cylindrical portion to cause the metallurgical bond, molecular bond or mechanical bond to form between the cylindrical portion and the metallic outer hose covering substantially completely along the extent and the circumference of the cylindrical portion to form a seal.

29. The method of claim 26, wherein forming the metallurgical bond or molecular bond comprises creating eddy currents in the outer hose covering and the fitting.

30. The method of claim 26, wherein the outer hose covering comprises a braided wire.

31. The method of claim 26, wherein the inner hose portion comprises one of a metallic material or a polymeric material.

32. A hose assembly, comprising:
a hose including at least an inner hose portion and an outer hose covering formed from a metallic type material;
a metallic fitting, wherein a cylindrical portion of the metallic fitting is inserted into the hose; and
one of a metallurgical bond, a molecular bond or a mechanical bond formed between the outer hose covering and the fitting without heat damaging the hose assembly.

33. The hose assembly of claim 32, wherein the metallurgical bond, molecular bond or mechanical bond is formed between the outer hose covering and the cylindrical portion of the metallic fitting substantially completely along an extent of the cylindrical portion and a circumference of the cylindrical portion to form a seal.

34. The hose assembly of claim 33, wherein the metallurgical bond, molecular bond or mechanical bond is formed by one of electromagnetic forming (EMF) or magnetic pulse welding (MPW).

35. The hose assembly of claim 32, wherein the outer hose covering comprises a braided wire.

36. The hose assembly of claim 32, wherein the inner hose portion comprises one of a metallic type material or a polymeric type material.

37. The hose assembly of claim 32, wherein the inner hose portion comprises a convoluted bellows.

38. The hose assembly of claim 37, further comprising one of a metallurgical bond, a molecular bond or a mechanical bond formed between the convoluted bellows and the cylindrical portion of the fitting by one of EMF or MPW.

39. A hose assembly, comprising:
a conduit;
a metallic fitting, wherein an end of the conduit is inserted into a sleeve portion of the metallic fitting; and
one of a metallurgical bond, a molecular bond or a mechanical bond formed between the sleeve of the fitting and the conduit without heat damaging the hose assembly by directing a magnetic pulse on the sleeve portion of the fitting.

40. The hose assembly of claim of 39, wherein the metallic fitting is a flexible ball joint.

41. The hose assembly of claim 40, further comprising a bellows disposed with the flexible ball joint.

42. The hose assembly of claim 41, further comprising a metallurgical bond, a molecular bond or a mechanical bond between a end portion of the bellows and the ball joint for sealing contact between the end portion of the bellows and the ball joint, wherein the bond is formed by a magnetic pulse directed on an interface between the end portion of the bellows and the ball joint.

43. The hose assembly of claim 41, further comprising a liner disposed within the bellows.

44. The hose assembly of claim 43, further comprising a metallurgical bond, a molecular bond or a mechanical bond between the end portion of the bellows and an end portion of the liner, wherein the bond is formed by a magnetic pulse directed on an interface between the liner and the bellows.
